(19) United States
(12) Patent Application Publication
(10) Pub. No.: US 2005/0216917 A1
(43) Pub. Date: Sep. 29, 2005

(54) Method and system for data object transformation

(76) Inventors: Srivatsa Krishnaswamy, Bangalore (IN); Nicholas Parkyn, (US); Jayadeva Gali Babu, Chittoor (IN); Birosh Thomas Heldad, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/808,223

(22) Filed: Mar. 23, 2004

(51) Int. Cl. G06F 9/46

(52) U.S. Cl. 719/315

(57) ABSTRACT

In accordance with an aspect of the present invention, a method of data object transformation is disclosed. The method includes receiving a message from a communications line, the message including one or more data objects of a first object type, wherein the message is in a first communications format, converting the message from the first communications format to a second communications format, converting the one or more data objects from the first object type to a second object type, wherein the one or more data objects are converted using a first set of one or more transformation classes, each of the one or more transformation classes generated using mapping rules, and transmitting the converted one or more second object type data objects to an application.

### FIELD OF THE INVENTION

The present invention relates generally to computer systems, and more specifically, to using a data transformation adapter to transform a data object from a first format to a second format.

### BACKGROUND OF THE INVENTION

Enterprise application integration (EAI) is a business computing term for the plans, methods, and tools aimed at consolidating and coordinating computer applications in an enterprise. Generally, an enterprise is an organization that uses computers, and the term encompasses such organizations as corporations, small businesses, non-profit institutions, government bodies, and any other type of organization. Enterprise application integration may include existing applications and databases or include a new encompassing structure of an enterprise's business and its applications.

Computer networks have become integral to businesses in conducting transactions with both their customers and other businesses. A number of different network systems have been developed for specific applications and to meet the specific needs of users.

A middleware bus may be incorporated into a communications network to provide secure communications between applications on the network. The middleware bus, or message bus, allows parties to send and receive asynchronous communications over the network. Accordingly, applications may send messages without having to wait for receiving applications to process the messages. Messaging middleware has become widely used in support of business-to-business (B2B) and business-to-consumer (B2C) transactions, these transactions often occurring over the Internet. A message bus may be part of a local area network (LAN).

In communications network environments, each application will have different data schema. In order to achieve application integration, the messages may need to be converted from one format to another format. One application for performing such a conversion is by using extensible stylesheet language (XSL) transformations (XSLT). XSLT is used to transform an extensible markup language (XML) document into a new XML document, which can have a different structure.

However, XSLT and other existing methods have not fully addressed the issues relating to data transformation in a communications network environment. Accordingly, there remains a need for a method and system device that solves existing shortcoming relating to data transformation.

### SUMMARY OF THE INVENTION

In accordance with one aspect of the present invention, a method of data object transformation is disclosed. The method includes receiving a message from a communications line, the message including one or more data objects of a first object type, wherein the message is in a first communications format, converting the message from the first communications format to a second communications format, converting the one or more data objects from the first object type to a second object type, wherein the one or more data objects are converted using a first set of one or more transformation classes, each of the one or more transformation classes generated using mapping rules, and transmitting the converted one or more second object type data objects to an application.

It is to be understood that other aspects of the present invention will become readily apparent to those skilled in the art from the following detailed description where, simply by way of illustration, exemplary embodiments of the invention are shown and described. As will be realized, the invention is capable of other and different embodiments, and its several details are capable of modifications in various respects, all without departing from the invention. Accordingly, the drawings and description are to be regarded as illustrative in nature and not as restrictive.

### BRIEF DESCRIPTION OF THE DRAWINGS

These and other features, aspects, and advantages of the present invention will become better understood with regard to the following description and accompanying drawings where:

FIG. 1 is an architecture diagram of a communications line including a data transformation adapter, in accordance with an embodiment of the present invention.

FIG. 2 is an architecture diagram of the data transformation adapter including development components, in accordance with an embodiment of the present invention.

FIG. 3 is a flow diagram of the development, configuration, and run time processes, in accordance with an embodiment of the present invention.

FIG. 4 an object diagram of a system name space including classes and objects, in accordance with an embodiment of the present invention.

FIG. 5 is a block diagram of an exemplary architecture for a general-purpose computer suitable for operation of the data transformation adapter, and related applications, in accordance with an embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

In the following description, reference is made to the accompanying drawings, which form a part hereof, and through which is shown by way of illustration specific embodiments in which the invention may be practiced. It is to be understood that other embodiments may be used as structural and other changes may be made without departing from the scope of the present invention.

In accordance with one embodiment, the method and system may be included in enterprise application integration or as part of an enterprise management system. One exemplary management system is the Integrated Service Management (ISM) Solution available from Hewlett Packard. The management system may include a communications network. In one embodiment, the communications network includes middleware for facilitating communications between any number of applications, servers, components, and/or users. However, other software or applications may be used to facilitate communication over the communications network.

One embodiment provides generally for a data transformation system and method of performing data transformations on network objects. In an exemplary embodiment, the data transformation system includes a data transformation adapter. The adapter performs transformations between a domain object model format (DOM) and an application specific object model format (ASOM). In one exemplary embodiment, domain objects and application objects are Java objects. However, the adapter may be used with any desired type of computer-readable object. The general environment in which the data transformation adapter and associated components function, will be referred to generally throughout the specification as “the data transformation system” or “the system.”

In one exemplary embodiment, the data transformation adapter receives the data object from a communications network or a communications line. In one embodiment, the communications line, or communications network, may be a message bus or messaging middleware. The data transformation adapter may be a software component that allows applications to be interfaced with the communications network. In another exemplary embodiment, the data transformation adapter receives the data object from an application.

In an exemplary data transformation system, a domain object model (DOM), which is an object oriented representation of domain entries, and application specific object models (ASOMs), which are definitions of objects in an application, are available. The incoming message to the adapter is aimed at performing a high level operation on the application and achieving the required result. This higher-level operation is part of one or more contracts that an adapter supports. A contract is much like an IDL (interface definition language) interface definition. This adapter model is designed to align and conform to the OSSIJ specification for telecommunication management interface. An operation is similar to a method in IDL of RMI (remote method invocation) or CORBA (common object request broker architecture). An operation may have an XML event specification. The XML payload in the event is parsed and presented to the data transformation layer. The objects in the input parameter list are of the types defined in the DOM and they are converted to the ASOM types. Similarly, reverse transformation takes place from the ASOM to the DOM before a message is assembled and transmitted. In one exemplary embodiment, data transformations happen at a high rate and the performance of a transformation engine is high.

Each application on the communication network may define its own internal object model, referred to as the ASOM. The environment of the particular communications network system defines the DOM.

A process manager, which may be an application or utility for controlling and monitoring communications on the enterprise management system, generally utilizes data in the DOM format. Since the applications generally process and transmit data in a format that is incompatible with the DOM format, a transformation of the data may be required. Through transformation, application generated data conforms to the DOM format, and data received from the network may be processed by the receiving application. In one embodiment, the DOM format and ASOM formats support all Java data types.

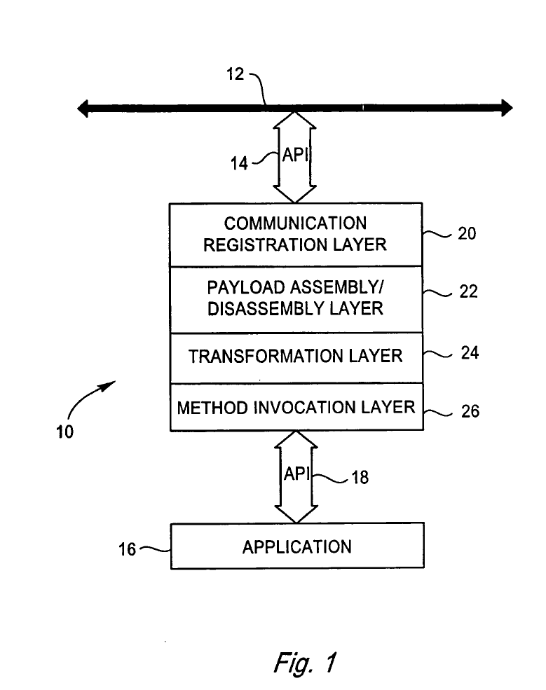

Referring now to FIG. 1, an architecture diagram of messaging middleware 12 including the data transformation adapter 10, in accordance with an embodiment, is shown. In the illustrated embodiment, the data transformation adapter 10 is coupled to the messaging middleware 12 with a middleware application-programming interface (API) 14. While FIG. 1 includes messaging middleware 12, any communications line or any suitable network connection may be used. The adapter 10 is coupled to an application 16 with an application API 18. The illustrated adapter 10 includes four layers between the middleware API 14 and the application API 18, the communication/registration layer 20, the payload assembly/disassembly layer 22, the transformation layer 24, and the method invocation layer 26.

The communication/registration layer 20 performs the two main functions of communication and registration. The communication/registration layer 20 interfaces with the APIs provided by the messaging middleware. The communication function generally uses a publish and subscribe paradigm that causes the communication/registration layer 20 of the adapter 10 to publish message data to the messaging middleware and subscribe to message data communicated on the messaging middleware 12. The registration function includes a “plug and play” feature that allows the communication/registration layer 20 to register the application in the system environment.

Generally, upon start-up, the adapter 20 communicates on a default communications channel, authenticates itself, and registers with the system environment. Registration is generally achieved by exporting contracts for all components supported by the adapter 10. The communication/registration layer 20 may also perform initialization of the middleware components. The higher level functions of the communication/registration layer 20 may be specific to the particular messaging middleware being used. The format of the input received and output transmitted by the communication/registration layer 20 is generally specific to the type of middleware being used. In one exemplary embodiment, middleware available from TIBCO Corporation is used. In this embodiment, for example, messages may be transmitted and received in TIBCO AE and/or RV message format.

The payload assembly/disassembly layer 22 converts data from the middleware-specific data format to a middleware-independent format. For disassembly, the assembly/disassembly layer 22 receives the data from communication/registration layer 20 in the middleware specific data format and converts the data to the middleware independent format. For example, using TIBCO middleware, the communication/registration layer 20 transmits the messages to the assembly/disassembly layer 22 in AE or RV format. The assembly/disassembly layer 22 converts the received messages to XML or Java Objects, thereby isolating upper layers from lower layers. For message assembly, the assembly/disassembly layer 22 receives the messages in the middleware-independent format and converts them into the middleware-specific format.

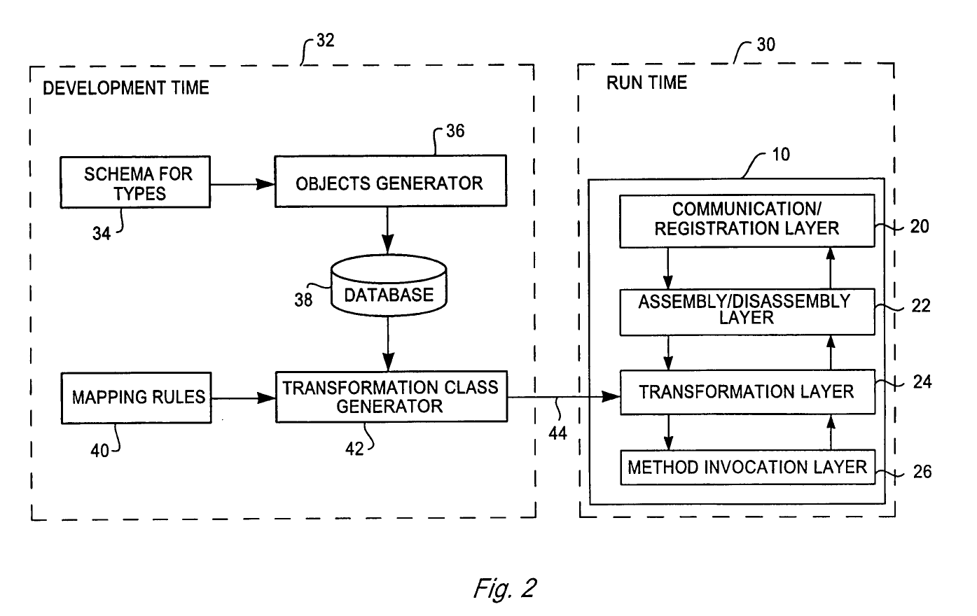

The transformation layer 24 transforms data from the DOM format to the ASOM format, and/or from the ASOM format to the DOM format. For example, such a data transformation may be needed when integrating commercial off-the-shelf (COTS) applications into the system. In accordance with an exemplary embodiment, bi-directional transformation allows communication between the particular application and the middleware. Since the applications generally process and transmit data in a format that is incompatible with the DOM format, a transformation of the data may be required. Therefore, the ASOM objects are exposed through the transformation layer. Transformation of data into and out of applications is used to make the data appear conformant to the DOM format. Data may be transformed from the DOM to the ASOM format, and vice versa, using transformation classes, described with reference to FIG. 2. Accordingly, the transformation layer 24 may output either data in the DOM format to the assembly/disassembly layer 22, or data in the ASOM format to the method invocation layer 26.

The method invocation layer 26 transmits and receives data to and from the application. The data is sent to the application as arguments to the methods supported by the high-level functions. The application API 16 is invoked to perform the required functionality. The method invocation layer 26 maps high-level function to “atomic” API calls, thereby invoking the required functionality of the application. In one embodiment, the method invocation layer 26: (a) identifies the corresponding high-level function to be invoked from adapter configuration data, which may be loaded when adapter starts up; and/or (b) invokes the high-level function with the incoming data.

FIG. 2 is an architecture diagram of the data transformation adapter including development components, in accordance with an embodiment. Processes are illustrated as occurring at run time 30 or at development time 32. In one embodiment, development time may occur any amount of time prior to the run time of the data transformation. XML schema 34 for object types are provided to the objects generator 36. In one embodiment, the DOM and ASOM object types are represented in XML schema. An example DOM XML schema, having the file name Customer_dom.xsd, is as follows:

```
<?xml version=“1.0”?>
<xsd:schema xmlns:xsd=“http://www.w3.org/2001/XMLSchema”
          elementFormDefault=“qualified”>
  <xsd:element name=“Customer”>
    <xsd:complexType>
      <xsd:sequence>
        <xsd:element name=“Id” type=“xsd:integer”/>
          <xsd:element name=“isOrdinaryPerson”
type=“xsd:boolean” default=“false”/>
          <xsd:element name=“OrderDate” type=“xsd:date”/>
      </xsd:sequence>
    </xsd:complexType>
  </xsd:element>
  </xsd:schema>
```

An example ASOM XML schema, having file name Person_asom.xsd, is as follows:

```
<?xml version=“1.0”?>
<xsd:schema xmlns:xsd=“http://www.w3.org/2001/XMLSchema”
          elementFormDefault=“qualified”>
  <xsd:element name=“Person”>
    <xsd:complexType>
      <xsd:sequence>
        <xsd:element name=“Id” type=“xsd:integer”/>
          <xsd:element name=“isOrdinaryPerson”
              type=“xsd:boolean” default=“false”/>
          <xsd:element name=“OrderDate” type=“xsd:date”/>
      </xsd:sequence>
    </xsd:complexType>
  </xsd:element>
</xsd:schema>
```

The objects may be generated using the object generator 36. In one embodiment, objects are created using a command line utility. In one exemplary embodiment, the command line utility is a wrapper on top of a source code generator available under the name Castor. However, other suitable object generators may be used. Castor is an open source data binding framework for Java. The Castor source code generator creates a set of Java classes, which represents an object model for an XML Schema. An example command line is:
>ObjectGenerator -i sample.xsd -package com.hp.ism.
   The above command line generates a set of source files from the XML schema and places them in com/hp/ism/* package. The source files are then compiled. The object generator 36 accepts two parameters from the command line: (a) schema file name; and (b) package name. These two parameters are passed to the source code generator utility with the following command line options: (a) -nodesc; and (b) -nomarshall. Option (a) instructs the generator utility to not generate class descriptors, and option (b) instructs the generator utility to not generate marshalling framework methods.

Example files that are input to and output from the object generator 36 are included at the end of this specification.

In an exemplary embodiment, the data transformation system operates on Java objects. However, other object types may be supported. In one embodiment, the generated Java classes, are stored in a specified directory structure in a file system on a database 38 or other memory. The directory structure may be specified by the administrator or user of the system.

Transformation mapping rules 40 are provided to the transformation class generator 42. In an exemplary embodiment, the mapping rules are written in an XML format using a rule specification guide. An example transformation XML document is a follows:

```
<?xml version = “1.0” encoding = “UTF-8”?>
<transformations source = “ismlite” target = “vpnsc”>
  <transformation name = “CreatePerson”>
  <!-- Source Element is array and Target Element is an array of size
  same as source element-->
    <Map type = “LineOrder”>
    <Service>
      <id>lineId</id>
      <cercRole isArray = “true” type = “function” ns =
      “com.hp.ism.afw.telib”>
          getArrayElement(cercType,0,5)
      </cercRole>
    </Service>
    </Map>
  </transformation>
  </transformations>
```

In an exemplary embodiment, the following rules, examples, and guidelines may be applied to object transformation in any suitable combination.

Transformations for an application can be specified in multiple files, although a single file may be used. Transformation file names may have the following format:
File name: <Application Name>_{DA/AD}_<SerialNo>.xml.
   Usage of a serial number in the file name allows the usage of multiple files to represent transformation for an application. Source and target represent names of the applications involved. DOM to ASOM transformations and ASOM to DOM transformations may be stored in separate physical XML files.

The following is an example transformation specification:

```
<?xml version=”I .0”?>
<transformations source=”Source” target = “Target” version=”I_0”>
  <transformation name = “name of transformation” >
  . . .
  . . .
  <transformation>
    <transformation name = “name of transform ation”>
    . . .
    . . .
    <transformation>
</transformations>
```

The names of the transformation represents an event transformation or object transformation.

The following is example XML code for identifying the source object for transformation:

```
<transformation name = “name of transformation”>
  <Map Type=”Customer” name = “name of the object”>
  {. . . rules for transformation for a particular customer . . .}
  </Map>
</transformation>
```

Map type indicates the source object type. If multiple fields of the same object type are present in the input, the name can be used to identify the field. The source object should be an element in identified type, i.e. a reference to the object.

The following is example XML code for target object creation:

```
<Map Type =“Customer”>
  <Person name = “name of the object”>
  </Person>
</Map>
```

Any of the following rules for target object creation may be applied in any desired combination:
1. If name attribute is not given, name is considered as the name of the class.
2. Target object can be qualified by <Object Name1>.<Object name2>:
   <Person.BillingAddress>
3. If target object is not already created, create the object. If target object present in the scope, get the object reference.
4. If Source element is array, target object will be by default assumed as an array:
   <Person isArray=“True”>
5. By default size of the array will be size of the source element in case it is the first occurrence of the target element.
6. If target array needs to be created with a specific size, then size attribute should be specified:
   <Person isArray=“True” Size=10>.
7. If the source array is larger than destination array, remaining parameter in the source elements will be ignored after logging a warning.
8. If the source element has lesser elements than size, then only elements in the source array will be copied to the target array.
9. To pad up the remaining element if necessary:
   <Person isArray=“True” Size=10 Pad Up=“True”>
   Remaining elements of the target array will be filled with last element of source selection.
10. If the source needs to copy to the selected portions of the target (size parameter is must if it is first time reference):
   <Person isArray=“True” size=10 min=“S” max=“7”>
11. If it is target element array is already created by prior occurrences, data will be copied from the first element and all the previous conditions apply.
12. Add the following to the current instance of the array for all of the previous conditions to apply:
   <Person isArray=“True” additive=“True”>
13. If source element is an array and target is a single element, proper selection should be done on source to get the single element for assignment.
14. If source is a single element and target is an array, source element will be copied to first of the selected elements of the target unless pad up attribute is not given.
15. Mapping specification will maintain the current context unless explicitly specified with fully qualified object name.
16. Qualification=“Relative/Absolute “provides the name space resolution tip. Default qualification is relative.
17. All elements should be specified inside the class.

The following is example XML code for target element selection:

```
<Map Type =“Customer”>
  <Person>
    <id> . . . . </id>
  </Person>
</Map>
```

The rules for target element selection may be the same or similar to the rules for target object creation. The target element may be in the target object scope. Type of assignment can be specified using the following type attributes:
1. Type=“Element” (Default value); indicating the assignment of elementary data items.
2. Type=“Function”; indicating value returned by the function needs to be assigned.
3. Type=“Constant”; indicating the assignment of constant data to the target.

The following is example XML code for source element selection:

```
<Map Type =“Customer”>
  <Person>
    <id> CusotmerID </id>
  </Person>
</Map>
```

Regarding source element selection, the element is selected from the source object and assigned into the target element. The source element can be qualified using the following syntax: <Object Name1>.<Object name2>. Source and target elements should have same type or be implicitly convertible. See the below description on type cast for a description of assigning data elements of different data types. Elements may be selected from the array using the getarray expression such as, for example: getArrayElement(source element, starting index, end index).

The following is example XML code for applying the expression on source data elements and assigning them to the target object:

```
<Map Type =“Customer”>
  <Person>
    <Name Type =“Function”> Uppercase
  (concat(firstname,lastname)) </Name> </Person>
</Map>
```

The following rules for writing expressions may be applied in any suitable combination:
1. Functions are developed as set of library classes, which will be the part of ADTE package.
2. ADTE package will have library jar file (adte_lib.jar), which needs to be in CLASSPATH.
3. This class path needs to be present in program generation time and during the transformation time also.
4. All functions need to be implemented as static methods in the library package.
5. Name space for the standard library will be com.hp.ism.afw.translib
6. Expression will be evaluated as:
   com.hp.afw.translib.<Function Library Class name>.<function>(arguments)
   ex: com.hp.afw.translib.Uppercase.Uppercase (string)
7. Nested functions are allowed.
8. Expression can be classified broadly into 2 types: (a) Elementary functions, and (b) Aggregate functions
9. Solution engineer can develop the custom function and add to the transformation engine by putting it into the classpath.
10. Attribute Group=“yes” indicates the function is group function that performs on array of elements.
11. In case of the custom made functions specify the name space using:
   <Name Type=“Function” ns=“ccustom classpath>”>Uppercase (concat (firstname, lastname)) <Name>
12. A function value can be used as the value of an attribute:
   <Name isArray=“True” size=“gCount(Customer)”>

The following is example XML code for auto filling of the elements that helps to assign similar elements of the source to the target:

```
<Map Type =“Customer”>
  <Person AutoFill=”True”>
    {. . . Mapping statement for non-similar attributes. . .}
  </Person>
</Map>
```

The above example XML code may be used to copy similar variables from source objects to the target. Similar attributes those with the same name, which may be suitable for implicit data conversion. Explicit mapping statements should be given for non-similar attributes.

Typecasting of elements may be used to assign dissimilar data types. Automatic conversion of data implicitly convertible elements may be allowed. The following is example XML code to covert the data of different types:

```
<Map Type =“Customer”>
    <Person>
        <ID Type= “Function”> toString(CUSID) </ID>
    </Person>
</Map>
```

The following is example XML code for conditional mapping including assigning the elements based on conditions:

```
<Map Type =“LineOrder”>
    <DSLLine>
        <if test = “equals(role, ‘main’)”>
            <mainbw>bandwidth</mainbw>
                </if.
                <if test = “equals(role, ‘backup’)”>
                    <mainbw>bandwidth</mainbw>
                </if>
            <siteAddress>siteAddress</siteAddress>
    </DSLLine>
</Map>
```

Conditions may be expressed as strings. Relational and logical operators may be provided as standard library functions. Nested conditions may be used. In one embodiment, test conditions are evaluated to be either true or false. Expressions may be used in conditions.

The following is example XML code used to include the transformations rules. For example, for including object transformation in the event transformation container:

```
<transformations source=“Source” target = “Target” version=“1_0”>
    <transformation name = “name of transformation”>
        <include name = “Transformation name”/>
            <Map srcobject=“Customer” name = “name of the object”>
                {...Rules for transformation of customer...}
            </Map>
    <transformation>
</transformations>
```

The transformation class generator 42 generates transformation wrappers using the command line utility using the transformation mapping rules 40 as input. For example, in one embodiment, a WrapperGen utility (using castor, in one embodiment) is used. In one embodiment, the various classes, including the DOM, the ASOM, and the wrappers, are kept in a proper package structure, so that these classes will be available at run-time. Package structure for the transformation class may be the package structure passed from the class generation utility such as, for example, Wrapper Gen, appended with the name of the target and the name of the transformation. For example, assume the following transformation map:

```
<transformations source=“ColombiaMovil” target = “RTB”
version=“1_0”>
    <transformation name = “TransCustomer”>
                ....
    <transformation>
</transformations>;
```

and the class generation utility syntax:
WrapperGen <name of the xml file>-p com.hp.ism.
   The generated file will be in the package: com.hp.ism.RTB.TransCustomer.

At run-time, the necessary transformation classes will be identified depending on the particular objects in the message. Accordingly, a group or set of transformation classes may be used to transform objects from the DOM to the ASOM, and a different group or set of transformation classes may be used to transform objects from the ASOM to the DOM. The same set of transformation classes may be used for both transformations, if necessary. The set of transformation classes may depend on which objects are being transformed. A pre-defined method in the transformation class is used to transform the data from DOM to ASOM format and/or from the ASOM format to the DOM format. In accordance with the pre-defined method, each transformation class may be of following syntax:
ObjectCollector transform (ObjectCollector sourceCollector) throws java.lang.Exception,
   where ObjectCollector is a generic class for data representation.

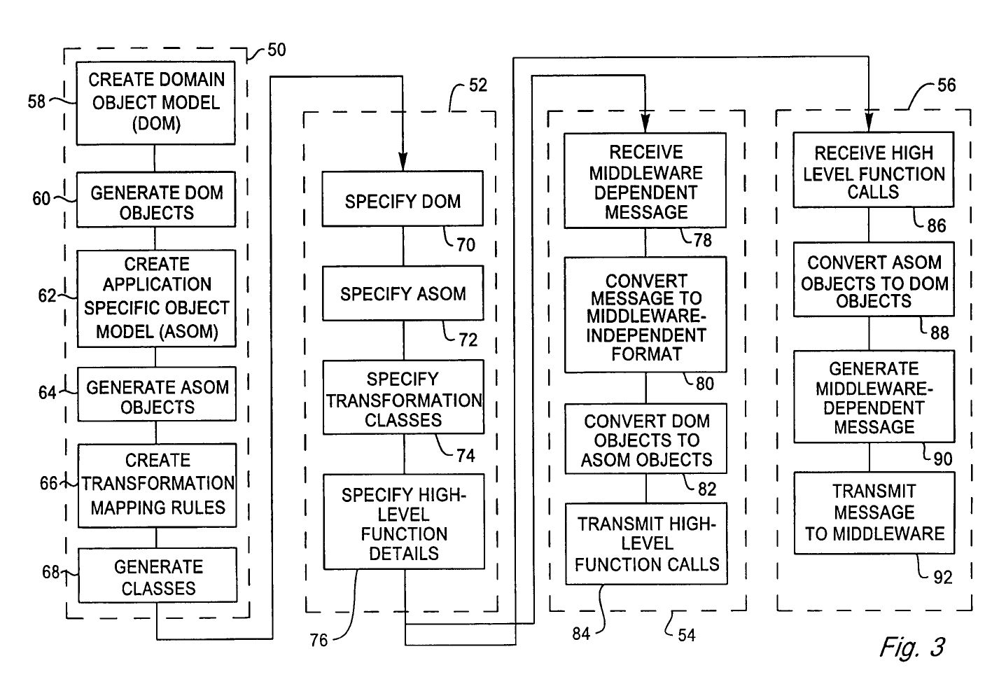

FIG. 3 is a flow diagram of development, configuration, and run time processes, in accordance with an embodiment. The flow diagram includes an example scenario for performing a desired application function using the system. The processes are illustrated as belonging to development 50, configuration 52, first run time 54, and second run time 56 groups, as illustrated by dashed line groupings. Modifications to the groupings may be made as desired. The specific groupings shown are solely for illustrative purposes and is included as an example of one possible sequence of events. For example, each of the individually illustrated processes may occur at any desired time. Additionally, the processes may occur in any desired order, including simultaneous occurrence. Depending on the particular function or application being used, not all of the illustrated processes may be necessary, and additional processes not shown may also be included.

The first run time 54 and second run time 56 groups identify separate transformation operations. The first run time 54 process illustrates a transformation from the DOM to the ASOM format. The second run time 56 process illustrates transformation from the ASOM to the DOM format. At step 58, objects for the DOM for the application are identified and/or created. At step 60, the DOM objects are generated in the system. At step 62, objects for the ASOM for the application are identified and/or created. At step 64, the ASOM objects are generated in the system. In step 66, mapping rules are created to transform objects from the DOM format to ASOM format, and from the ASOM format to the DOM format. In one embodiment, a developer, user, or system administrator creates the required XML mapping rules using the mapping rules illustrated in the present specification. The mapping rules may also be automatically generated for specific functions by the system. In step 68, Java classes are generated using the XML mapping rules. In one embodiment, the XML mapping rules are converted to Java classes using a WrapperGen utility.

In steps 70 through 76, the adapter is configured for the particular application being used. In step 70, the user creates and/or specifies the DOM. In step 72, the user creates and/or specifies the ASOM. In step 74, the user specifies and/or inputs the transformation classes. In step 76, the user specifies and/or inputs high-level function details for the application in an adapter configuration file. The high-level function detail may relate to a single utility, operation, or function of the application, or a group of utilities, operations, or functions.

The use of the terms “create,” 'specify,” and “input” may include the creation or generation of elements by a user or developer of the system, or the automated generation of elements by the system. For example, in one embodiment, the DOM and the ASOM, including the various classes and objects in each of the models, are designed by the system developer. Also, for example, each of the models, classes, and objects may be created and stored in memory when files including source code are compiled by the system. In another embodiment, the transformation mapping rules developed by the system developer and XML schema are manually generated by the system developer. However, mapping rules by be automatically generated by the system.

In step 78, at run time, the data transformation system receives the middleware-dependent message format. At step 80, the transformation system converts to message to a middleware-independent data format, the message including the DOM objects. At step 82, the transformation system converts the DOM objects to ASOM objects. At step 84, the system calls the high-level functionality of application layer.

In step 86, at run time, the transformation system receives high-level function calls from the application. At step 88, the transformation system converts the ASOM objects to DOM objects. A message is generated including the DOM objects, step 90. The generated message may be in a middleware-dependent format. However, a conversion from middleware-independent format to middleware-dependent format may be performed if necessary. In step 92, the message is transmitted to the middieware.

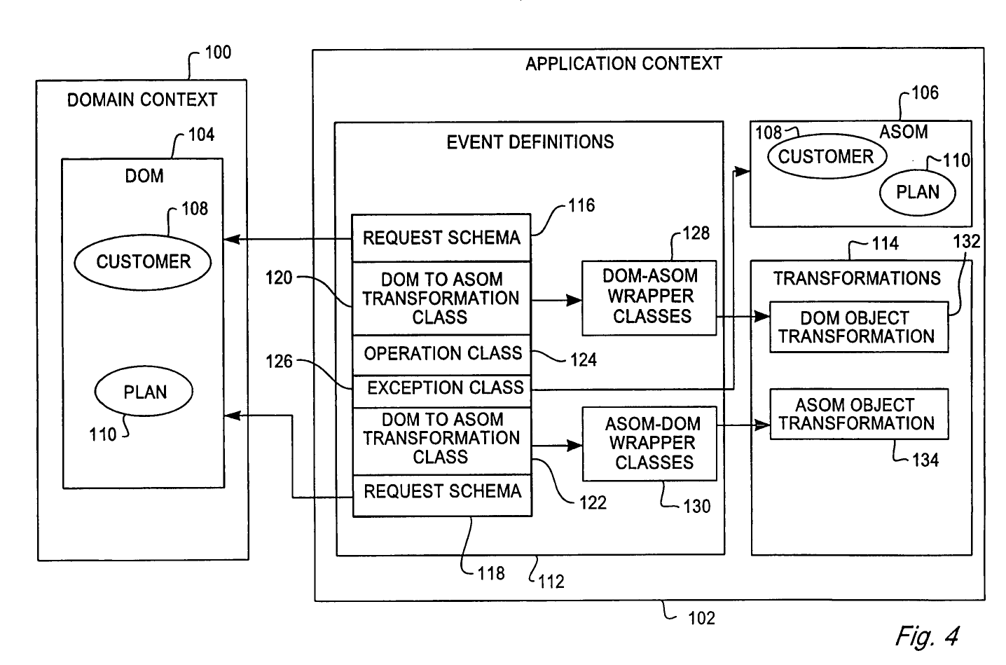

Referring now to FIG. 4, an object diagram of the system name space including the classes and objects, in accordance with an embodiment, is shown. The data transformation system includes a domain context 100 and an application context 102. The domain context 100 includes the domain object model (DOM) 104. The application context 102 includes the application specific object model (ASOM) 106. Each of the DOM 104 and the ASOM 106 may include any number of objects. The DOM objects define data items in the domain format. An example path for a DOM object is com.hp.ism.<PRODUCT_NAME>.object.<OBJECT_NAME>. The ASOM objects define data items in the applications. An example path for an ASOM object is com.hp.ism.<APPLICATION_NAME>.object.<OBJECT_NAME>. The DOM 104 and the ASOM 106 illustrated each have a customer object 108 and a plan object 110.

The application context 102 further includes event definitions 112 and transformations 114. The event definitions 112 include request schema 116, response schema 118, a DOM to ASOM transformation class 120, an ASOM to DOM transformation class 122, an operation class 124, and an exception class 126. Event transformation classes represent the transformation required for the particular event. The event transformation class may include the object transformation class and event specific transformation requirements. Object transformation rule classes represent the transformation rules that are needed to transform the objects from one format to another. In one embodiment, each transformation may have a unique name that identifies a transformation class. An example full class path of the transformation object is: com.hp.ism.<APPLICATION>.<TRANSFORMATION_NAME>. The DOM to ASOM transformation class 120 is a pointer in an event definition file, which is the adapter configuration that is used by the system user to load the DOM to ASOM transformation wrapper class 128 during runtime. Event definitions load during the start-up of the adapter and will be referred to during runtime. The ASOM to DOM transformation class 122 is a pointer in the event definition file used to identify the ASOM to DOM transformation wrapper class 130 that is used for ASOM to DOM transformations. The DOM to ASOM wrapper class 128 contains a DOM object transformation 132 included in the transformations 114. The ASOM to DOM wrapper class 130 is contains an ASOM transformation 134 included in the transformations 114.

In an exemplary embodiment, each object has a corresponding transformation wrapper class. In another embodiment, each event has an event transformation wrapper class that includes an object transformation class and event specific transformation instructions. Each application context may have one or more events. In one embodiment, all data objects and all transformation objects are represented in the application context. Each transformation may have a unique name that is used to identify the transformation within the application context. In another embodiment, a domain object model (DOM) is created. The system, or an enterprise management system solution, may also be treated as a single application that understands and operates using the DOM.

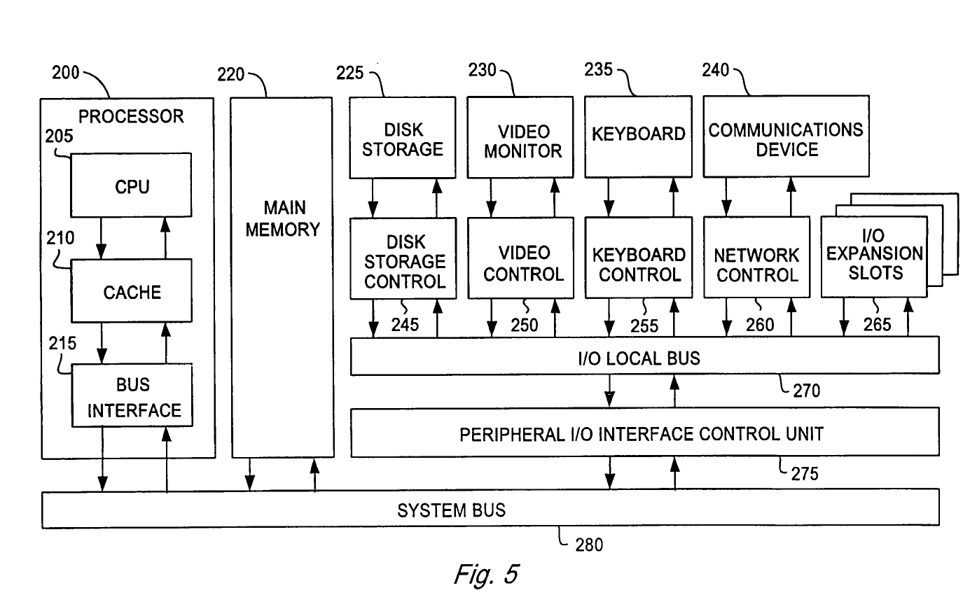

FIG. 5 is a block diagram of an exemplary architecture for a general purpose computer suitable for operating the network inventory adapter. The illustrated general purpose computer may also be suitable for running other network applications. A microprocessor 200, including of a central processing unit (CPU) 205, a memory cache 210, and a bus interface 215, is operatively coupled via a system bus 280 to a main memory 220 and an Input/Output (I/O) control unit 275. The I/O interface control unit 275 is operatively coupled via an I/O local bus 270 to a disk storage controller 245, video controller 250, a keyboard controller 255, a network controller 260, and I/O expansion slots 265. The disk storage controller 245 is operatively coupled to the disk storage device 225.

The video controller is operatively coupled to the video monitor 230. The keyboard controller 255 is operatively coupled to the keyboard 235. The network controller 260 is operatively coupled to the communications device 240. The communications device 240 is adapted to allow the network inventory adapter operating on the general purpose computer to communicate with a communications network, such as the Internet, a Local Area Network (LAN), a Wide Area Network (WAN), a virtual private network, or a middleware bus, or with other software objects over the communications network.

Computer program instructions for implementing the network inventory adapter may be stored on the disk storage device 225 until the processor 200 retrieves the computer program instructions, either in full or in part, and stores them in the main memory 220. The processor 200 then executes the computer program instructions stored in the main memory 220 to implement the features of network inventory adapter. The program instructions may be executed with a multiprocessor computer having more than one processor.

The general purpose computer illustrated in FIG. 5 is an example of a one device suitable for performing the various functions of the data transformation system. The data transformation adapter 10, and any other associated applications, components, and operations, may also run on a network server or other suitable computers and devices.

Those skilled in the art will appreciate that the above-described system may be implemented in a variety of configurations. For example, while particular communications protocols are specified, any suitable communications protocol and communications media may be used. For example, communications lines may include ISDN lines, ADSL lines, DSL lines, T-carrier lines, E-carrier lines, wireless communication, such as infrared or RF-based wireless communication, and the like. Also, while certain communications protocols may have been specified, those skilled in the art that other suitable communications protocols may be used. Additionally, while development, configuration, and un-time operation processes have been specified, the three processes may occur in any combination and at any desirable times. For example, the three processes may occur at different points in time or the same time, sequentially or simultaneously. Furthermore, while some processes have been described as requiring user input or generation, it should be apparent that all described functionality may either be automated or performed by a user or system administrator, or a combination of the two, as is suitable for the desired application.

The following example XML document, having the filename merchanttosupplier.xml, includes transformation rules used as input to the object generator utility to create Java format transformation classes:

```
<?xml version=“1.0” encoding=“UTF-8” ?>
- <transformations source=“ismlite” target=“netmf”>
  - <transformation name=“MerchantToSupplier”>
    - <Map type=“Merchant”>
      - <Supplier>
          <Id>Id</Id>
          <FirstName>FirstName</FirstName>
          <LastName>LastName</LastName>
          <PhoneNumber>PhoneNumber</PhoneNumber>
        - <Map type=“Location”>
          - <Location>
              <Street>Street</Street>
              <City
                type=“function”>concat(City,City)</City>
            </Location>
          </Map>
        </Supplier>
      </Map>
    </transformation>
        </transformations>
```

The following is an example of Java transformation classes output by the object generator that correspond to the above example XML document:

```
/*
* $ld$
*/
package com.hp.ism.netmf.transformation;
//---------------------------------/
//- Imported classes and packages -/
//---------------------------------/
import com.hp.ism.afw.transformation.*;
import com.hp.ism.afw.util.*;
import com.hp.ism.afw.util.ObjectCollector;
import com.hp.ism.afw.util.TransformationUtility;
import com.hp.ism.ismlite.object.*;
import com.hp.ism.netmf.obiect.*;
import java.util.*;
/**
*
* @version $Revision$ $Date$
**/
public class MerchantToSupplier implements
      com.hp.ism.afw.transformation.ITransform {
    //--------------------------/
  //- Class/Member Variables -/
  //--------------------------/
  private com.hp.ism.afw.util.ObjectCollector sourceCollector = null;
  private com.hp.ism.afw.util.ObjectCollector targetCollector = null;
  private com.hp.ism.afw.util.TransformationUtility transUtility = null;
    //-----------/
  //- Methods -/
  //-----------/
  /**
  **/
  public void MerchantToSupplier( )
  {
  } //-- void MerchantToSupplier( )
  /**
  *
  * @param sourceCollector
  **/
  public com.hp.ism.afw.util.ObjectCollector
      transform(com.hp.ism.afw.util.ObjectCollector sourceCollector)
    throws java.lang.Exception
  {
      this.sourceCollector = sourceCollector;
      this.targetCollector = new ObjectCollector( );
      this.transUtility = new TransformationUtility( );
      transform_Merchant(null,null);
      return targetCollector;
  } //-- com.hp.ism.afw.util.ObjectCollector
      transform(com.hp.ism.afw.util.ObjectCollector)
  /**
  *
  * @param srcObject
  * @param tarObject
  **/
  public void transform_Merchant(java.lang.Object srcObject, java.lang.Object
        tarObject)
    throws java.lang.Exception
  {
      com.hp.ism.ismlite.object.Merchant ismlite_merchant = null;
      ismlite_merchant = (com.hp.ism.ismlite.object.Merchant)
        sourceCollector.getObjectByType(“Merchant”);
      com.hp.ism.netmf.object.Supplier netmf_supplier = null;
      netmf_supplier =
        (com.hp.ism.netmf.object.Supplier)transUtility.getTargetUtility(target
        Collector, “com.hp.ism.netmf.object.”,“Supplier”,null);
      netmf_supplier.setId(ismlite_merchant.getId( ));
      netmf_supplier.setFirstName(ismlite_merchant.getFirstName( ));
      netmf_supplier.setLastName(ismlite_merchant.getLastName( ));
        netmf_supplier.setPhoneNumber(ismlite_merchant.getPhoneNumber( ));
      transform_Merchant_Location(ismlite_merchant,netmf_supplier);
  } //-- void transform_Merchant(java.lang.Object, java.lang.Object)
  /**
  *
  * @param srcObject
  * @param tarObject
  **/
  public void transform_Merchant_Location(java.lang.Object srcObject,
        java.lang.Object tarObject)
    throws java.lang.Exception
  {
      com.hp.ism.ismlite.object.Location ismlite_merchant_location = null;
      ismlite_merchant_location =
        (com.hp.ism.ismlite.object.Location)((com.hp.ism.ismlite.object.Merchant)
        srcObject).getLocation( );
      com.hp.ism.netmf.object.Supplier netmf_supplier =
        (com.hp.ism.netmf.object.Supplier ) tarObject;
      com.hp.ism.netmf.object.Location netmf_supplier_location = null;
      netmf_supplier_location =
        (com.hp.ism.netmf.object.Location)transUtility.getTargetUtility(target
        Collector, “com.hp.ism.netmf.object.”,“Location”,tarObject);
        netmf_supplier_location.setStreet(ismlite_merchant_location.getStreet( ));
        netmf_supplier_location.setCity(com.hp.ism.afw.telib.concat.fn_concat
        (ismlite_merchant_location.getCity( ),ismlite_merchant_location.getCity( )));
  } //-- void transform_Merchant_Location(java.lang.Object, java.lang.Object)
}
```

The previous description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of data object transformation, the method including:
receiving a message from a communications line, the message including one or more data objects of a first object type, wherein the message is in a first communications format;
converting the message from the first communications format to a second communications format;
converting the one or more data objects from the first object type to a second object type, wherein the one or more data objects are converted using a first set of one or more transformation classes, each of the one or more transformation classes generated using mapping rules; and
transmitting the converted one or more second object type data objects to an application.

2. A method according to claim 1, wherein the communications line is messaging middleware, and the first communications format is a middleware-dependent format, and the second communications format is a middleware-independent format.

3. A method according to claim 1, wherein each of the one or more data objects is a Java object.

4. A method according to claim 1, wherein the first object type is a domain object model type and the second object type is an application-specific object model type.

5. A method according to claim 1, further including:
registering the application with the communications line; and
transmitting high-level function calls to the application.

6. A method according to claim 1, the method further including:
receiving a second message from the application, the second message including one or more data objects of the second object type;
converting the one or more data objects from the second object type to the first object type, wherein the one or more data objects are converted using a second set of one or more of the transformation classes;
generating a communications line dependent message, the communications line dependent message including the converted one or more first object type data objects; and
transmitting the communications line dependent message to the communications line.

7. A method according to claim 6, wherein the communications line is messaging middleware, and the first communications format is a middleware-dependent format, and the second communications format is a middleware-independent format.

8. A method according to claim 6, wherein each of the one or more data objects is a Java object.

9. A method according to claim 6, wherein the first object type is a domain object model type and the second object type is an application-specific object model type.

10. A method according to claim 6, further including:
registering the application with the communications line; and
transmitting high-level function calls to the application.

11. A method of data object transformation, the method including:
generating a first object model and a second object model, the first object model including a plurality of data objects of a first object type, and the second object model including a plurality of data objects of a second object type;
storing the first and second object models in one or more memories;
generating transformation mapping rules;
generating a plurality of transformation classes using the first and second object models and the transformation mapping rules;
receiving one or more data objects;
converting the received one or more data objects, using the transformation classes, from (1) the first object type to the second object type; or (2) from the second object type to the first object type; and
transmitting the converted one or more data objects.

12. A method according to claim 11, wherein each of the one or more data objects is a Java object.

13. A method according to claim 11, wherein the first object model is a domain object model and the second object model is an application-specific object model.

14. A method according to claim 11, wherein the first object type is a domain object model type and the second object type is an application-specific object model type.

15. A method according to claim 11, wherein the one or more data objects are receive from messaging middleware.

16. A method according to claim 11, wherein the one or more data objects are receive from an application, the application coupled to a communications line.

17. A system for data object transformation, the system including:
one or more processors;
one or more memories coupled to the one or more processors; and
program instructions stored in the one or more memories, the one or more processors being operable to execute the program instructions, the program instructions including:
receiving a message from a communications line, the message including one or more data objects of a first object type, wherein the message is in a first communications format;
converting the message from the first communications format to a second communications format;
converting the one or more data objects from the first object type to a second object type, wherein the one or more data objects are converted using a first set of one or more transformation classes, each of the one or more transformation classes generated using mapping rules; and
transmitting the converted one or more second object type data objects to an application.

18. A system according to claim 17, wherein the communications line is messaging middleware, and the first communications format is a middleware-dependent format, and the second communications format is a middleware-independent format.

19. A system according to claim 17, wherein each of the one or more data objects is a Java object.

20. A system according to claim 17, wherein the first object type is a domain object model type and the second object type is an application-specific object model type.

21. A system according to claim 17, wherein the program instructions further include:
receiving a second message from the application, the second message including one or more data objects of the second data format;
converting the one or more data objects from the second object type to the first object type, wherein the one or more data objects are converted using a second set of one or more of the transformation classes;
generating a communications line dependent message, the communications line dependent message including the converted one or more first object type data objects; and
transmitting the communications line dependent message to the communications line.

22. A system for data object transformation, the system including:
a communications line;
a transformation adapter coupled to the communications line, the transformation adapter including:
an assembly/disassembly layer configured to convert messages from a first communications format to a second communications format;
a transformation layer configured to convert data objects from a first object type to a second object type using one or more transformation classes; and
a method invocation layer;
a transformation class generator coupled to the transformation adapter, the transformation class generator configured to generate the one or more transformation classes using transformation mapping rules; and
an application coupled to the transformation adapter, wherein the application transmits data to and receives data from the method invocation layer.

23. A system according to claim 22, wherein the communications line is messaging middleware.

24. A system according to claim 22, wherein each of the one or more data objects is a Java object.

25. A system according to claim 22, wherein the first object type is a domain object model type and the second object type is an application-specific object model type.

26. An apparatus for data object transformation, the apparatus including:
means for generating a first object model and a second object model, the first object model including a plurality of data objects of a first object type, and the second object model including a plurality of data objects of a second object type;
means for storing the first and second object models;
means for generating transformation mapping rules;
means for generating a plurality of transformation classes using the first and second object models and the transformation mapping rules;
means for receiving a one or more data objects:
means for converting the received data objects, using the transformation classes, from the first object type to the second object type; and
means for transmitting the converted one or more data objects.
